(19) United States
(12) Patent Application Publication
(10) Pub. No.: US 2004/0065167 A1
(43) Pub. Date: Apr. 8, 2004

(54) Electronic accelerator pedal system with a foot pressure-adjusting function

(76) Inventor: Duck-Ki Kim, Gyeonggi-do (KR)

Correspondence Address: MORGAN, LEWIS & BOCKIUS, LLP., 3300 HILLVIEW AVENUE, PALO ALTO, CA, 94304, US

(21) Appl. No.: 10/443,945

(22) Filed: May 21, 2003

(30) Foreign Application Priority Data
Oct. 4, 2002 (KR) 2002-60654

(51) Int. Cl. G05G 1/14

(52) U.S. Cl. 74/560

(57) ABSTRACT

An electronic accelerator pedal system with a foot pressure-adjusting function. The foot pressure is variably adjusted with respect to the pedal arm stroke during the depressing and releasing of the accelerator pedal to improve the accelerator manipulation sensation. A foot pressure-adjusting means is installed on the pedal arm that causes a foot pressure to be varied in accordance with the pivoting direction of the pedal arm.

### FIELD OF THE INVENTION

Generally, the present invention relates to an electronic accelerator pedal system with a foot pressure-adjusting function. More particularly the electronic accelerator pedal incorporates a system that provides variable resistance with respect to the stroke of the pedal arm during depression and release of the accelerator pedal.

### BACKGROUND OF THE INVENTION

Typically, an accelerator manipulation device is either a mechanical device or an electronic device. The mechanical accelerator pedal system includes a pedal that is pivotally mounted on the driver's side floorboard, a throttle mechanism installed in the intra-engine suction system, and a cable connecting the accelerator pedal to the throttle mechanism that transmits a manipulation force. An electronic accelerator pedal system includes an accelerator pedal pivotally mounted on the driver's side floorboard and a detection sensor installed on the accelerator pedal that detects the position of the accelerator pedal on a real time basis.

A conventional mechanical accelerator pedal system generates a foot pressure hysteresis effect, and thus, no special problem occurs in the foot pressure tuning of the accelerator pedal. The foot pressure hysteresis effect refers to a phenomenon where a driver's passive reaction force (about 2 kgf), caused from friction of the cable during the releasing of the pedal, is small compared to the driver's passive reaction force (about 3.5˜4.5 kgf) during the depressing of the pedal. In contrast, in a conventional electronic accelerator pedal system the driver's passive reaction force, during depression, steady state, and release of the pedal, is determined only by the inherent elasticity of a return spring. The quantitative degree of the reactive force of the return spring is determined on the basis of depression of the pedal for acceleration. However, a drawback of this system is that there is no resistance in the system which counteracts the spring's reactive force while a driver holds a steady accelerator position. As a result, the driver's ankle is subjected to fatigue after repetitive depressions of the pedal. Consequently, the manipulability of the accelerator is aggravated.

### SUMMARY OF THE INVENTION

The present invention provides an electronic accelerator pedal system with a foot pressure-adjusting function. The pivoting of the pedal is electrically detected to determine the degree of acceleration requested by the driver. The reactive foot pressure felt by the driver is made variable during the depressing and releasing of the pedal. Therefore, the driver's fatigue during frequent manipulation of the pedal is reduced, thereby improving the manipulability of the accelerator.

In accordance with an embodiment of the present invention, the electronic accelerator pedal system with a foot pressure-adjusting function comprises a pedal arm pivotally installed within a car interior. Additionally, a detection sensor for detecting the degree of pedal arm movement and a foot pressure-adjusting means is installed on the pedal arm for varying the foot pressure in accordance with the pivoting direction of the pedal arm. Furthermore, a contact member for contacting the foot pressure-adjusting means during the pivoting of the pedal arm is included.

In an alternative embodiment the electronic pedal system comprises a pedal arm pivotally coupled with a structural body and a detector sensor for detecting an amount of movement of the pedal arm. An elastic member generates a return force against movement of the pedal arm. Also included is a pressure-adjusting system that comprises a first friction member coupled to the pedal arm and a second friction member coupled to the structural body. The second friction member is configured and dimensioned to contact the first friction member and the contact between the friction members opposes movement of the pedal arm.

### BRIEF DESCRIPTION OF THE DRAWINGS

For a fuller understanding of the nature and objects of the present invention, reference should be made to the following detailed description taken in conjunction with the accompanying drawings in which:

FIG. 1 is an exploded perspective view of an embodiment of the electronic accelerator pedal system of the present, invention with a foot pressure-adjusting function;

FIG. 2 is a perspective view showing the assembled state of the electronic accelerator pedal system of FIG. 1;

FIG. 3 illustrates an enlarged view of the coupling portion between the pedal arm and the foot pressure-adjusting means of FIG. 1;

FIG. 4 is a perspective view of a contact member that accommodates and contacts the foot pressure-adjusting means of FIG. 1;

FIG. 5 illustrates the contact state between the foot pressure-adjusting means and the contact member during the depressing and releasing of the accelerator pedal;

FIG. 6 is a graphical illustration showing the variation of the foot pressure with respect to the accelerator pedal stroke;

FIG. 7 illustrates another embodiment of the foot pressure-adjusting means according to the present invention;

FIG. 8 illustrates still another embodiment of the foot pressure-adjusting means according to the present invention; and

FIG. 9 illustrates yet another embodiment of the foot pressure-adjusting means according to the present invention.

### DETAILED DESCRIPTION OF THE PREFERRED EMBODIMENTS

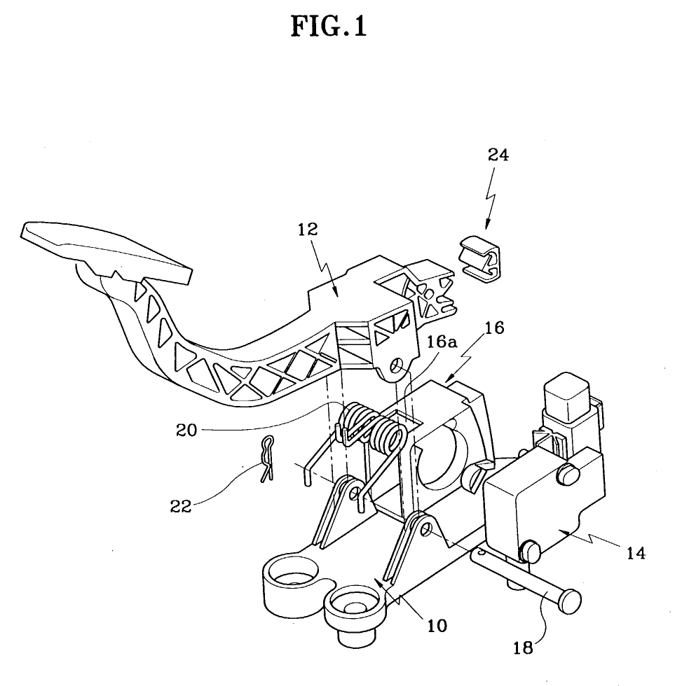

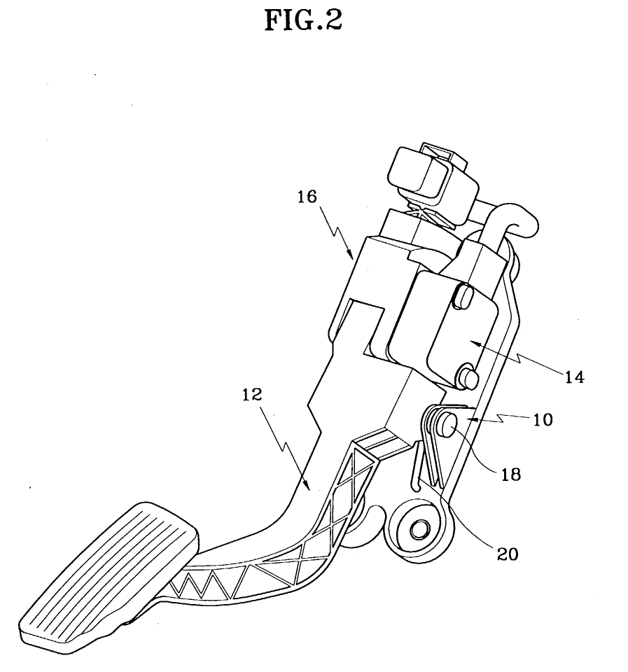

As shown in FIGS. 1 and 2, the electronic accelerator pedal system with a foot pressure-adjusting function according to the present invention includes a housing 10 secured to a lower panel within a car's interior. A pedal arm 12 is pivotally installed on the housing 10 and a detection sensor 14, such as a potentiometer, is secured on one side of the housing 10. The detection sensor 14 electrically detects the degree the pedal arm 12 is pivoted during use. A foot pressure-adjusting means is installed on the pedal arm 12 for varying the foot pressure in accordance with the pivoting direction of the pedal arm 12. Also, a contact member 16 is formed on the leading end of the housing 10 for contacting the foot pressure-adjusting means during the pivoting of the pedal arm.

A pivot-supporting fastening pin 18 is coupled to the housing 10 and the pedal arm 12 provide pivot of the pedal arm 12 with respect to the housing 10. A pair of torsion springs 20 are fitted to the fastening pin 18 to elastically pivot the pedal arm 12 in relation to the housing 10. On one end of the pivot-supporting fastening pin 18, there is a securing pin 22 for preventing the fastening pin 18 from becoming separated from the housing 10 and the pedal arm 12.

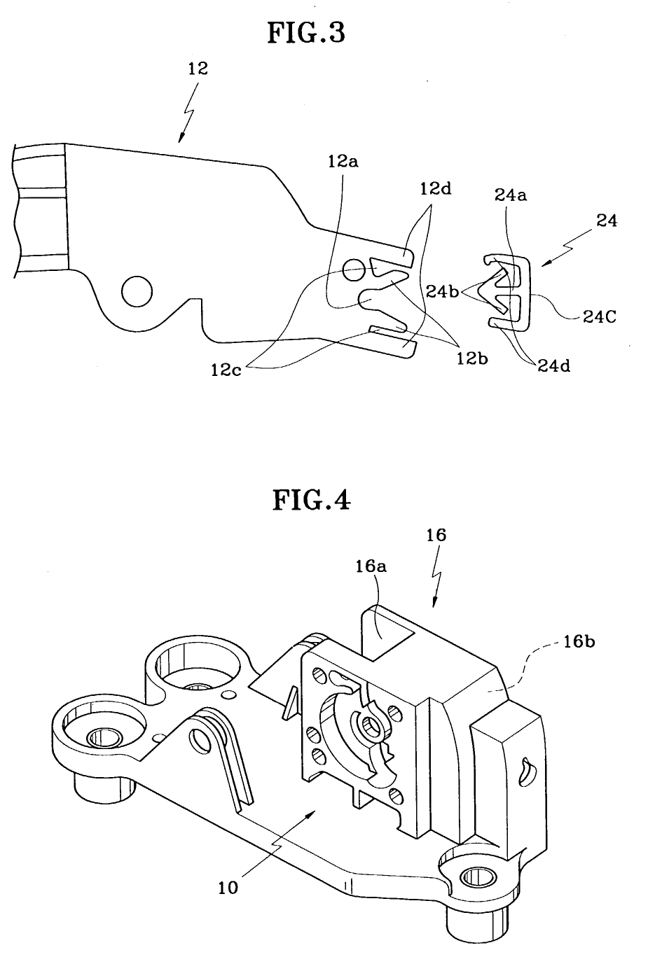

As shown in FIG. 3, the foot pressure-adjusting means includes a friction plate 24 that is detachably coupled to the leading end of the pedal arm 12. The friction plate 24 includes an elastic installation part 24a having a pair of inclinedly spread protuberance parts 24b that couple to the leading end of the pedal arm 12 to maintain an elastic supporting force. A contact part 24c integrally extends from the elastic installation part 24a to contact the contact member 16. Also included is pair of securing support parts 24d that integrally extend from both ends of the contact part 24c. The pair of securing support parts 24d couple to the leading end of the pedal arm 12 and generate a securing strength.

The leading end of the pedal arm 12 has a mounting slot 12a for elastically receiving the friction plate 24. The mounting slot 12a receives the elastic installation part 24a of the friction plate 24. The mounting slot 12a is formed by a pair of elastic protuberances 12b which are inclinedly spread out to be contacted to the elastic installation part 24a of the friction plate 24. Furthermore, two auxiliary protuberance parts 12d are formed outside two auxiliary mounting slots 12c for receiving the securing and supporting parts 24d of the friction plate 24.

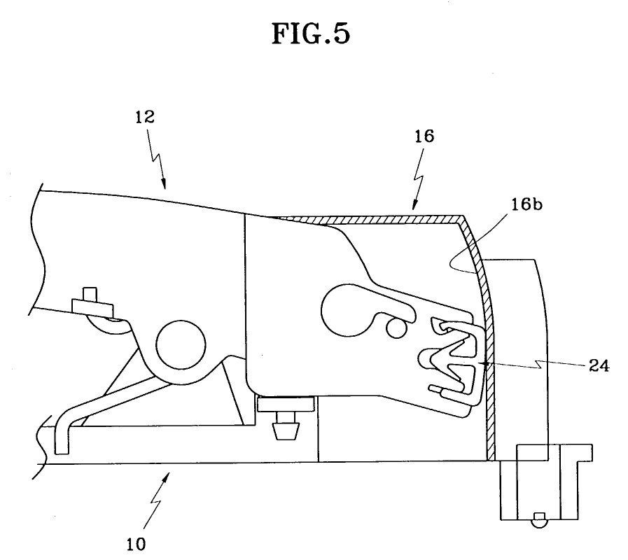

As shown in FIGS. 4 and 5, the leading end of the pedal arm 12 is pivotally installed into the contact member 16 which projects upward on the housing 10. The contact member 16 includes a space of an opening part 16a that opens in the front and receives the leading end of the pedal arm 12. A contact face 16b is vertically formed for contacting the friction plate 24 that functions as the foot pressure-adjusting means. The friction plate 24, which is coupled to the leading end of the pedal arm 12, maintains contact with the contact face 16b of the contact member 16 during the pivoting of the pedal arm 12.

In use, if the driver depresses the pedal arm 12 during acceleration, the pedal arm 12 pivots around the fastening pin 18 upon the housing 10. Under this condition, the contact part 24c of the fiction plate 24 sustains contact with the contact face 16b of the contact member 16 and generates friction.

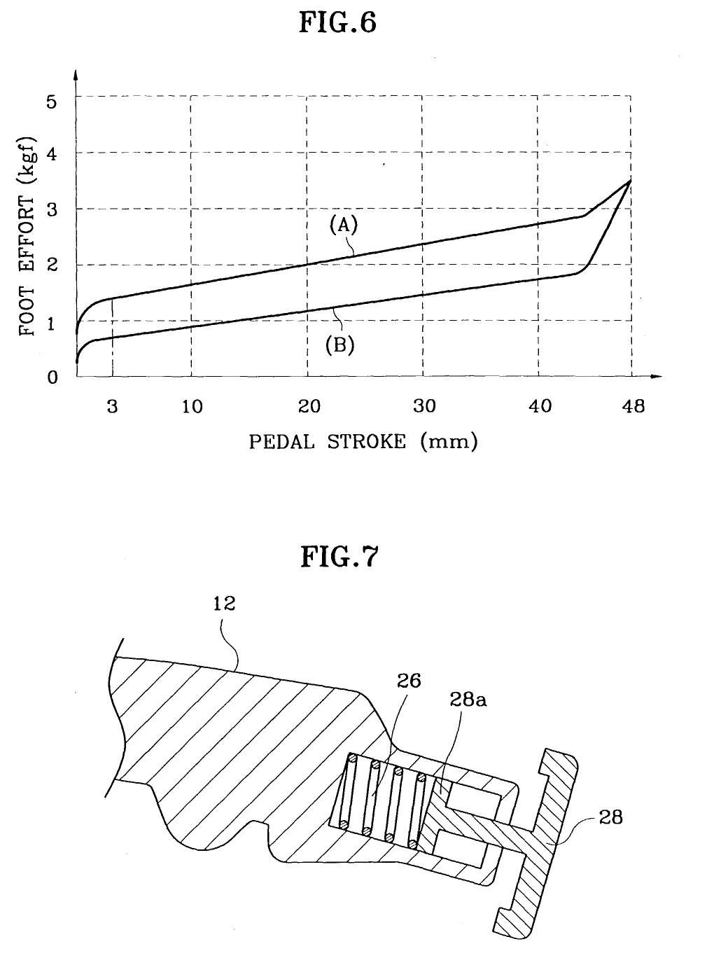

The degree of the driver's foot pressure that is transmitted to the pedal arm 12 varies depending on the direction of the friction force generated between the friction plate 24 and the contact member 16. That is, the degree of foot pressure required is variable depending on whether the driver is depressing the accelerator or releasing the accelerator, as graphically illustrated in FIG. 6. When the driver depresses the accelerator pedal, the variation of the foot pressure with respect to the stroke of the pedal arm 12 is equivalent to the sum of the inherent restoring force of the torsion spring 20 and the friction force generated between the friction plate 24 and the contact member 16. This is represented in graph A of FIG. 6.

If the driver releases the acceleration (this refers to the state where the driver releases the pedal arm to cause deceleration, or the driver maintains a constant velocity of the car), then the variation of the foot pressure is ascertained by the difference between the inherent elastic restoring force of the torsion springs 20 and the friction force (between the friction plate 24 and the contact member 16). This is represented in graph B of FIG. 6. That is, during a constant velocity, the direction of the friction force between the friction plate 24 and the contact member 16 is opposite to the direction of the elastic restoring force of the torsion spring 20. Therefore, if the driver desirers to maintain a constant car velocity, a foot pressure greater than the difference between the elastic restoring force of the torsion spring 20 and the friction force (between the friction plate 24 and the contact member 16) must be transmitted to the pedal arm 12.

Thus, during the depressing and releasing of the pedal arm, the reaction force which is received by the driver is different. Therefore, a foot pressure hysteresis can be formed, similar to the conventional mechanical cable-type accelerating system. Following adjustment to the elastic restoring force of the torsion spring 20 and the friction force between the friction plate 24 and the contact member 16, the foot pressure of the acceleration system can be set as desired.

The mounting slots 12a and the elastic protuberance part 12b together with the engaged elastic protuberance part 24b of the friction plate 24 forms an elastic restoring force which maintains contact between the friction plate 24 and the contact force 16b even following wear of the components. Therefore the foot pressure hysteresis is maintained. If grease or another lubricant is applied between the contact part 24c of the friction plate 24 and the contact face 16b of the contact member 16, noise generated by this contact can be prevented during the depressing and releasing of the pedal arm 12.

FIG. 7 illustrates another embodiment of the foot pressure-adjusting means according to the present invention. The foot pressure-adjusting means includes a contact plate 28 with its rear face elastically supported to the leading end of the pedal arm 12 through a return spring 26. In this embodiment, the contact plate 28 is substituted for the friction plate 24 of the earlier embodiment. Furthermore, a closed space is formed in the leading end of the pedal arm 12 for accommodating the return spring 26. An engaging part 28a is provided on the rear face of the contact plate 28 for preventing the return spring 26 from departing from the closed space.

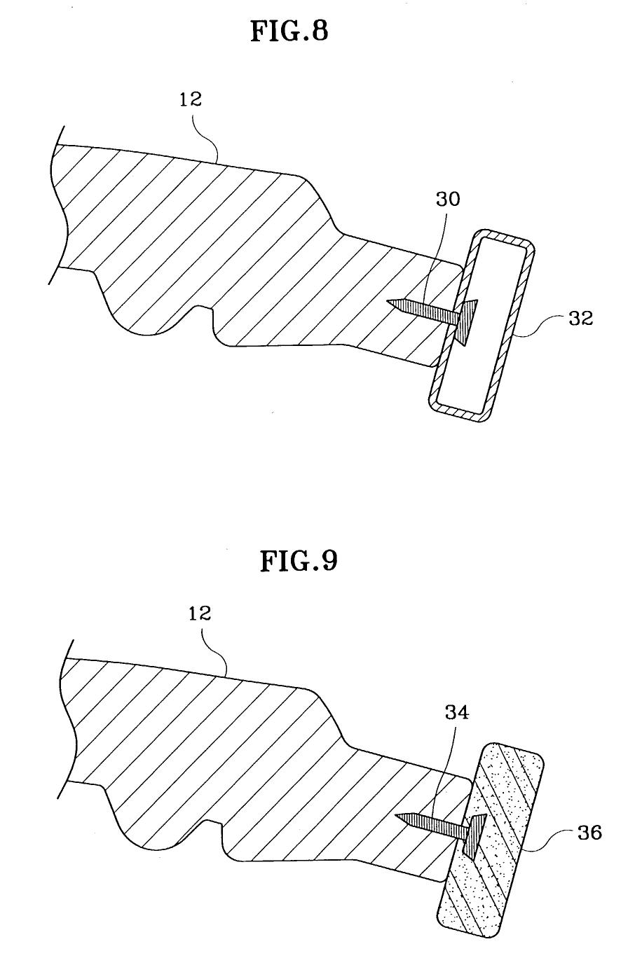

FIG. 8 illustrates still another embodiment of the foot pressure-adjusting means of the present invention. The foot pressure-adjusting means includes a hollow elastic plate 32 with its rear face secured to the leading end of the pedal arm 12 by means of a fastening pin 30. The front face faces toward the contact face 16b of the contact member 16. In this embodiment, the elastic plate 32 can be substituted for the friction plate 24 of the earlier embodiment.

FIG. 9 illustrates yet another embodiment of the foot pressure-adjusting means of the present invention. The foot pressure-adjusting means includes an elastic member 36 made of rubber, with its rear face secured to the leading end of the pedal arm 12 by means of a fastening pin 34. In this embodiment the elastic member 36 can be substituted for the friction plate 24 of the earlier embodiment of the present invention.

In the later described embodiments, the contact plate 28, the elastic plate 32 and the elastic member 36, which can be substituted for the friction plate 24 of the first embodiment, cause variations in the degree of foot pressure with respect to the stroke of the pedal arm 12 in the same manner as that of the earlier embodiment.

Many modifications and variations of the described embodiments will be apparent to one skilled in the art. The embodiments described in this application are intended for descriptive purposes and are not intended to limit the scope of the present invention. The scope of the present invention is defined by the appended claims, along with the full scope of equivalents to which such claims are entitled.

What is claimed is:

1. An electronic accelerator pedal system with a foot pressure-adjusting function, comprising:
a pedal arm pivotally installable within a car interior;
a detection sensor for detecting a pivoting degree of said pedal arm during a pivoting of said pedal arm;
a foot pressure-adjusting means installed on said pedal arm for causing a foot pressure to be varied in accordance with a pivoting direction of said pedal arm; and
a contact member for contacting said foot pressure-adjusting means during the pivoting of said pedal arm.

2. The electronic accelerator pedal system as claimed in claim 1, wherein said foot pressure-adjusting means comprises a friction plate, said friction plate comprising:
an elastic installation part with a pair of elastic protuberance parts formed thereon, and coupled to said pedal arm for forming an elastic supporting strength;
a contact part integrally extending from said elastic installation part for facially contacting a contact member; and
a pair of securing and supporting parts extending from two leading ends of said contact part for being coupled to said pedal arm to provide a supporting and securing strength.

3. The electronic accelerator pedal system as claimed in claim 2, wherein said pedal arm comprises:
a mounting slot formed by two inclined elastic protuberance parts for furnishing an elastic supporting force to the elastic protuberance part of said friction plate, and for accommodating the elastic installation part of said friction plate; and
two auxiliary mounting slots formed by two auxiliary protuberance parts for receiving said pair of securing and supporting parts of said friction plate.

4. The electronic accelerator pedal system as claimed in claim 1, wherein said contact member comprises:
an opening part frontally open for receiving the leading end of said pedal arm; and
a contact face for contacting said friction plate within said opening part.

5. The electronic accelerator pedal system as claimed in claim 1, wherein said foot pressure-adjusting means comprises: a contact plate with its rear face elastically contacting the pedal arm through a return spring.

6. The electronic accelerator pedal system as claimed in claim 1, wherein said foot pressure-adjusting means comprises: a hollow elastic plate with its rear face secured to said pedal arm by means of a fastening pin.

7. The electronic accelerator pedal system as claimed in claim 1, wherein said foot pressure-adjusting means comprises: an elastic member made of a rubber with its rear face secured to said pedal arm by means of a fastening pin.

8. An electronic pedal system, comprising:
a pedal arm configured and dimensioned to be pivotally coupled with a structural body;
a detector sensor for detecting an amount of movement of said pedal arm;
an elastic member wherein said elastic member generates a return force against movement of said pedal arm;
a pressure-adjusting system comprising:
a first friction member coupled to said pedal arm;
a second friction member coupled to the structural body wherein said second friction member is configured and dimensioned to contact said first friction member; and
wherein the contact between said first friction member and said second friction member opposes movement of said pedal arm.

9. The pedal system of claim 8, wherein said structural body is a floorboard of an automobile.

10. The pedal system of claim 8, wherein said pedal arm is an accelerator pedal.

11. The pedal system of claim 8, wherein said elastic member is a spring.

12. An electronic pedal system, comprising:
a pedal arm configured and dimensioned to be pivotally coupled within a vehicle;
an electronic detecting sensor for detecting an amount of movement of said pedal arm;
an elastic member wherein said elastic member generates a return force against movement of said pedal arm; and
a pressure-adjusting system comprising;
at least one member configured and dimensioned to interact between said pedal arm and the vehicle wherein said at least one member generates a resistive force against movement of said pedal arm.
